(19) United States
(12) Patent Application Publication
(10) Pub. No.: US 2017/0222515 A1
(43) Pub. Date: Aug. 3, 2017

(54) METHOD FOR CONNECTING EXTERNAL POWER WIRE AND THERMOSTAT, CONNECTOR COMPRISING EXTERNAL POWER WIRE AND THERMOSTAT, AND MOTOR COMPRISING THE SAME

(71) Applicants: Zhongshan Broad-Ocean Motor Co., Ltd., Zhongshan (CN); Hubei Queen-Ocean Electrical Appliance Manufacture Co., Ltd., Xiaogan (CN)

(72) Inventors: Zeyan JIANG, Zhongshan (CN); Wei LEI, Zhongshan (CN)

(21) Appl. No.: 15/491,963

(22) Filed: Apr. 19, 2017

Related U.S. Application Data
(63) Continuation-in-part of application No. PCT/CN2015/071480, filed on Jan. 23, 2015.

(30) Foreign Application Priority Data
Nov. 29, 2014 (CN) 201410713525.X

(51) Int. Cl. H02K 5/22; H01R 43/02; H02K 11/25; H01R 43/16; H01R 4/02; H01R 4/70; H01R 11/01; H01R 43/033

(52) U.S. Cl. CPC H02K 5/225; H01R 11/01; H01R 43/02; H01R 43/033; H01R 43/16; H01R 4/023; H01R 4/70; H02K 11/25

(57) ABSTRACT

A method for connecting an external power wire and a thermostat of a motor. The method includes: electrically connecting a first pin of the thermostat to the external power wire; electrically connecting a second pin of the thermostat to the enameled wire of the stator windings of the motor; intertwining and soldering the first exposed core end of the first pin and the second exposed core end of the external power wire to form a soldered common joint; pulling the first pin of the thermostat and the external power wire towards opposite directions, and bending a relatively longer core end of the first exposed core end and the second exposed core end to form a bent part; and arranging side by side the bent part and the soldered common join, and sheathing the bent part and the soldered common joint with an insulating sleeve.

### CROSS-REFERENCE TO RELATED APPLICATIONS

This application is a continuation-in-part of International Patent Application No. PCT/CN2015/071480 with an international filing date of Jan. 23, 2015, designating the United States, now pending, and further claims foreign priority benefits to Chinese Patent Application No. 201410713525.X filed Nov. 29, 2014. The contents of all of the aforementioned applications, including any intervening amendments thereto, are incorporated herein by reference. Inquiries from the public to applicants or assignees concerning this document or the related applications should be directed to: Matthias Scholl P. C., Attn.: Dr. Matthias Scholl Esq., 245 First Street, 18th Floor, and Cambridge, Mass. 02142.

### BACKGROUND OF THE INVENTION

Field of the Invention

The invention relates to a method for connecting an external power wire and a thermostat of a motor, a connector made by the method, and a motor comprising the connector.

Description of the Related Art

Typically, motors include a thermostat B. The thermostat B includes two pins B1 which are respectively connected to the stator windings A of the motors and an external power wire C. The connection often has the following two modes.
1.As shown in FIG. 1, one pin B1 of the thermostat B and the external power wire C are arranged side by side. The exposed end of the pin B1 of the thermostat B is intertwined with and soldered to the exposed end of the external power wire C. An insulating sleeve D is provided to cover the joint of the two exposed ends. In the connection mode, the pin and the external power wires are heaped up near the thermostat, which tends to damage the insulating layer of the stator windings.
2. As shown in FIGS. 2-3, the exposed end of the pin B1 of the thermostat B is intertwined with and soldered to the exposed end of the external power wire C. The pin B1 of the thermostat B and the external power wire C are pulled towards opposite directions, and the joint E of the two exposed ends is positioned side by side with the pin B1 of the thermostat B, or with the rubber portion C1 of the external power wire C. Thereafter, an insulating sleeve D is provided to cover the joint of the two exposed ends. In this way, although the pins and the external power wires are evenly distributed and not heaped up, the joint of the two exposed ends is irregular in shape, leading to the generation of sharp corners, which tend to damage the insulating sleeve and the stator windings.

### SUMMARY OF THE INVENTION

In view of the above-described problems, it is a first objective of the invention to provide a method for connecting an external power wire and a thermostat of a motor. The method is easily carried out, and the joint between the external power wire and the pin of the thermostat is regular in shape. Thus, the stator windings are prevented from being damaged, improving the quality and stability of the product.

It is a second objective of the invention to provide a connector comprising an external power wire and a thermostat. The connector is regular in shape, and the external power wire and the pin of the thermostat are uniformly distributed, which is favorable to improving the quality and stability of the product.

It is a third objective of the invention to provide a motor comprising the above-mentioned connector.

To achieve the above objective, in accordance with one embodiment of the invention, there is provided a method for connecting an external power wire and a thermostat of a motor, the motor comprising stator windings comprising an enameled wire, the thermostat comprising a first pin and a second pin, the first pin comprising a first exposed core end, the external power wire comprising a second exposed core end, and the method comprising:
electrically connecting the first pin of the thermostat to the external power wire; electrically connecting the second pin of the thermostat to the enameled wire of the stator windings of the motor;
intertwining and soldering the first exposed core end of the first pin and the second exposed core end of the external power wire to form a soldered common joint;
pulling the first pin of the thermostat and the external power wire towards opposite directions, and bending a relatively longer core end of the first exposed core end and the second exposed core end to form a bent part; and
arranging side by side the bent part and the soldered common join, and sheathing the bent part and the soldered common joint with an insulating sleeve.

In a class of this embodiment, a length of the first exposed core end is at least twice a length of the second exposed core end, and the bent part is formed by the first exposed core.

In a class of this embodiment, a length of the second exposed core end is at least twice a length of the first exposed core end, and the bent part is formed by the second exposed core end.

In a class of this embodiment, prior to intertwining and soldering the first exposed core end of the first pin and the second exposed core end of the external power wire, the first exposed core end of the first pin and the second exposed core end are aligned.

In a class of this embodiment, prior to aligning the first exposed core end of the first pin and the second exposed core end, the external power wire is sheathed with the insulating sleeve; following the pulling of the first pin of the thermostat and the external power wire towards opposite directions, the insulating sleeve is moved to sheathe the bent part and the soldered common joint.

A connector comprises a thermostat of a motor and an external power wire comprising a second exposed core end. The motor comprises stator windings comprising an enameled wire, the thermostat comprises a first pin and a second pin, and the first pin comprises a first exposed core end. The first pin of the thermostat is electrically connected to the external power wire; the second pin of the thermostat is electrically connected to the enameled wire of the stator windings of the motor; the first exposed core end of the first pin and the second exposed core end of the external power wire are intertwined and soldered to form a soldered common joint; the first pin of the thermostat and the external power wire are pulled towards opposite directions, and a relatively longer core end of the first exposed core end and the second exposed core end is bent to form a bent part; and the bent part and the soldered common joint are arranged side by side, and are sheathed in an insulating sleeve

In a class of this embodiment, the first exposed core end is longer than the second exposed core end, and the bent part is formed by the first exposed core.

In a class of this embodiment, the second exposed core end is longer than the first exposed core end, and the bent part is formed by the second exposed core end.

A motor comprises a rotary shaft, a rotor assembly, a stator assembly, a shell assembly, and a thermostat. The rotor assembly is disposed on the rotary shaft. The stator assembly and the shell assembly are integrated and sleeved on the rotor assembly. Two ends of the rotary shaft are supported by bearings of the shell assembly. The stator assembly comprises a stator core and stator windings. The stator windings are coiled on the stator core. The thermostat is disposed on the stator assembly. The thermostat comprises a first pin and a second pin; the first pin of the thermostat is electrically connected to an enameled wire on the stator windings, and the second pin of the thermostat is electrically connected to an external power wire; the first pin comprises a first exposed core end, and the external power wire comprises a second exposed core end; and the thermostat and the external power wire are connected according to the abovementioned method.

Advantages of the method, the connector, and the motor according to embodiments of the invention are summarized as follows:

1. The first exposed core end of the first pin and the second exposed core end of the external power wire are intertwined and soldered to form a soldered common joint. The pin of the thermostat and the external power wire are pulled towards opposite directions. A relatively longer core end of the first exposed core end and the second exposed core end is bent to form a bent part. The bent part and the soldered common joint are side by side, and are sheathed in an insulating sleeve. The method is easy to operate. The soldered common joint of the external power wire and the pin of the thermostat is regular in shape. The external power wire and the pin of the thermostat are evenly distributed. The stator windings are prevented from being damaged, improving the quality and stability of the product.

2. Prior to intertwining and soldering the first exposed core end of the first pin and the second exposed core end of the external power wire, the first exposed core end of the first pin and the second exposed core end are first aligned, thereby facilitating the connection between the first exposed core end and the second exposed core end by soldering. Thus, the working efficiency is improved, and the connection is reliable.

3. Prior to aligning the first exposed core end of the first pin and the second exposed core end, the external power wire is sheathed with the insulating sleeve; following the pulling of the first pin of the thermostat and the external power wire towards opposite directions, the insulating sleeve is moved to sheathe the bent part and the soldered common joint. The method is simple and easy to operate; thus the working efficiency is improved.

### BRIEF DESCRIPTION OF THE DRAWINGS

The invention is described hereinbelow with reference to the accompanying drawings, in which:

FIG. 1 is a diagram showing a connection between a thermostat and an external power wire in the prior art;

FIG. 2 is a diagram showing another way to connect a thermostat and an external power wire in the prior art;

FIG. 3 is a partial enlarged view of part III in FIG. 2;

FIG. 4 is a diagram showing a connecting process of a thermostat and an external power wire in accordance with one embodiment of the invention;

FIG. 5 is a diagram showing that a connection between a thermostat and an external power wire is completed in accordance with one embodiment of the invention;

FIG. 6 is an assembly diagram of a thermostat and stator windings in accordance with one embodiment of the invention;

FIG. 7 is a partial enlarged view of part VII-VII in FIG. 6; and

FIG. 8 is a schematic diagram of a motor in accordance with one embodiment of the invention.

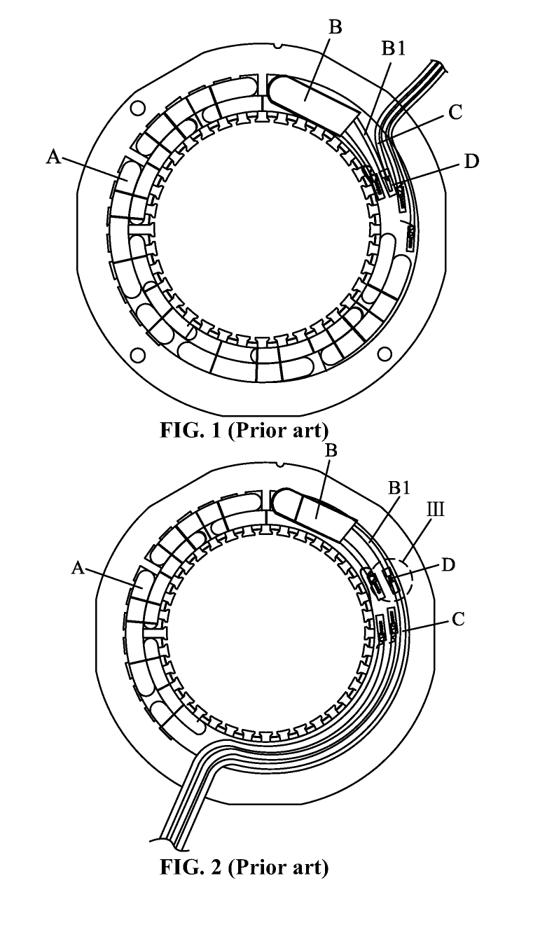

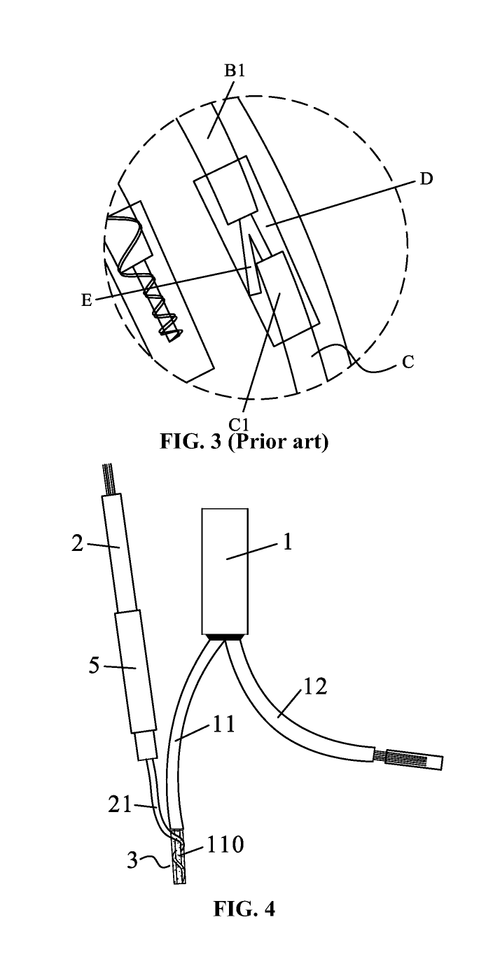

### DETAILED DESCRIPTION OF THE EMBODIMENTS

For further illustrating the invention, experiments detailing a method for connecting an external power wire and a thermostat of a motor, a connector made by the method, and a motor comprising the connector are described below.

### EXAMPLE 1

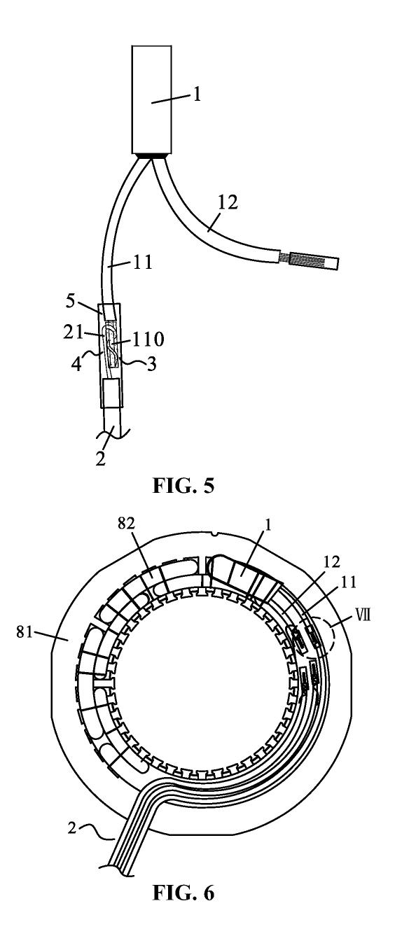

As shown in FIGS. 4-5, a method for connecting an external power wire and a thermostat comprises electrically connecting a second pin 12 of the thermostat 1 to an aluminum enameled wire of stator windings of a motor. A first pin 11 of the thermostat is electrically connected to the external power wire 2. The first pin 11 comprises a first exposed core end 110, the external power wire 2 comprises a second exposed core end 21.

As shown in FIG. 4, preferably, a length of the second exposed core end 21 is about twice a length of the first exposed core end 110. The external power wire 2 is sheathed in an insulating sleeve 5. The first exposed core end 110 is aligned with the second exposed stator core 21, then the first exposed core end 110 is intertwined with and soldered to the second exposed core end 21 to form a soldered common joint 3. The first exposed core end 110 is aligned with the second exposed core end 21, then the first exposed core end is intertwined with and soldered to the second exposed core end, thereby facilitating the connection between the first exposed core end 110 and the second exposed core end 21 by soldering. The working efficiency is improved, and the connection is reliable. The first pin 11 of the thermostat 1 and the external power wire 2 are pulled towards opposite directions, which means, the first exposed core end 110 and the second exposed core end 21 are pulled towards opposite directions by external force. A rear end of the second exposed core end 21 is bended to form a bent part 4. The bent part 4 and the soldered common joint 3 are side by side. The insulating sleeve 5 which is sleeved on the external power wire 2 is moved and is sleeved on the bent part 4 and the soldered common joint 3. As shown in FIG. 5, the method is simple and easy to operate, and the soldered common joint of the external power wire and the pin of the thermostat is regular in shape, thus the soldered common joint brings no harm to the insulating sleeve and the stator windings. The external power wire and the pin of the thermostat are evenly distributed, and cause no stacking, thereby facilitating the shaping of the stator windings, and reducing the risks of stator windings damage, and in general, the quality and stability of the product are improved.

While particular embodiments of the invention have been shown and described, it will be obvious to those skilled in the art that changes and modifications may be made without departing from the invention in its broader aspects, and therefore, the aim in the appended claims is to cover all such changes and modifications as fall within the true spirit and scope of the invention.

For example, in the example, the length of the second exposed core end 21 is about twice the length of the first exposed core end 110, and it is obvious to those skilled in the art that the length of the first exposed core end 110 may be about twice the length of the second exposed core end 21, or in other length relationships. All such changes and modifications fall within the true spirit and scope of the invention, and the invention covers all such changes.

### EXAMPLE 2

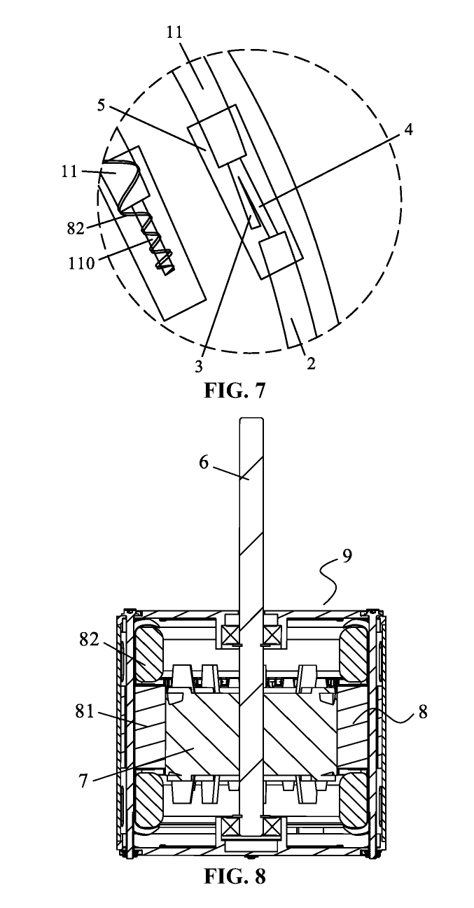

As shown in FIGS. 6-7, a connector comprises a thermostat 1 of a motor and an external power wire 2 comprising a second exposed core end 21. The motor comprises stator windings comprising an aluminum enameled wire, the thermostat 1 comprises a first pin 11 and a second pin 12, and the first pin 1 comprises a first exposed core end 110. The second pin 12 of the thermostat is electrically connected to the aluminum enameled wire of stator windings of the motor, and the first pin 11 of the thermostat is electrically connected to the external power wire 2. A length of the first exposed core end 110 is about twice a length of the second exposed core end 21. The first exposed core end 110 is intertwined with and soldered to the second exposed core end 21 to form the soldered common joint 3. The first exposed core end 110 is bended to form the bent part 4. The bent part 4 and the soldered common joint 3 are side by side, and the bent part 4 and the soldered common joint 3 are sheathed in an insulating sleeve 5.

### EXAMPLE 3

As shown in FIGS. 4-8, a motor comprises a rotary shaft 6, a rotor assembly 7, a stator assembly 8, a shell assembly 9, and a thermostat 1. The rotor assembly 7 is disposed on the rotary shaft 6. The stator assembly 8 and the shell assembly 9 are sleeved on the rotor assembly 7. Two ends of the rotary shaft 6 are supported by bearings of the shell assembly 9. The stator assembly 8 comprises a stator core 81 and stator windings 82. The stator windings 82 are coiled on the stator core 81. The thermostat 1 is disposed on the stator assembly 8. The thermostat 1 is provided with two pins. A second pin 12 of the thermostat is electrically connected to an aluminum enameled wire on the stator windings 82, and a first pin 11 of the thermostat is electrically connected to an external power wire 2. The first pin 11 comprises a first exposed core end 110, the external power wire 2 comprises a second exposed core end 21. A length of the second exposed core end 21 is about twice a length of the first exposed core end 110. As shown in FIG. 4, the external power wire 2 is sheathed in an insulating sleeve 5. The first exposed core end 110 is aligned with the second exposed core end 21, then the first exposed core end 110 is intertwined with and soldered to the second exposed core end 21 to form a soldered common joint 3. The first exposed core end 110 is aligned with the second exposed core end 21, then the first exposed core end is intertwined with and soldered to the second exposed core end, thereby facilitating the connection between the first exposed core end 110 and the second exposed core end 21 by soldering. The working efficiency is improved, and the connection is reliable. The first pin 11 of the thermostat 1 and the external power wire 2 are pulled towards opposite directions, which means, the first exposed core end 110 and the second exposed core end 21 are pulled towards opposite directions by external force. A rear end of the second exposed core end 21 is bended to form a bent part 4. The bent part 4 and the soldered common joint 3 are side by side. The insulating sleeve 5 which is sleeved on the external power wire 2 is moved and is sleeved on the bent part 4 and the soldered common joint 3, as shown in FIG. 5.

While particular embodiments of the invention have been shown and described, it will be obvious to those skilled in the art that changes and modifications may be made without departing from the invention in its broader aspects, and therefore, the aim in the appended claims is to cover all such changes and modifications as fall within the true spirit and scope of the invention.

The invention claimed is:

1. A method for connecting an external power wire and a thermostat of a motor, the motor comprising stator windings comprising an enameled wire, the thermostat comprising a first pin and a second pin, the first pin comprising a first exposed core end, the external power wire comprising a second exposed core end, and the method comprising:
electrically connecting the first pin of the thermostat to the external power wire; electrically connecting the second pin of the thermostat to the enameled wire of the stator windings of the motor;
intertwining and soldering the first exposed core end of the first pin and the second exposed core end of the external power wire to form a soldered common joint;
pulling the first pin of the thermostat and the external power wire towards opposite directions, and bending a relatively longer core end of the first exposed core end and the second exposed core end to form a bent part; and
arranging side by side the bent part and the soldered common join, and sheathing the bent part and the soldered common joint with an insulating sleeve.

2. The method of claim 1, wherein a length of the first exposed core end is at least twice a length of the second exposed core end, and the bent part is formed by the first exposed core.

3. The method of claim 1, wherein a length of the second exposed core end is at least twice a length of the first exposed core end, and the bent part is formed by the second exposed core end.

4. The method of claim 1, wherein prior to intertwining and soldering the first exposed core end of the first pin and the second exposed core end of the external power wire, the first exposed core end of the first pin and the second exposed core end are aligned.

5. The method of claim 2, wherein prior to intertwining and soldering the first exposed core end of the first pin and the second exposed core end of the external power wire, the first exposed core end of the first pin and the second exposed core end are first aligned.

6. The method of claim 3, wherein prior to intertwining and soldering the first exposed core end of the first pin and the second exposed core end of the external power wire, the first exposed core end of the first pin and the second exposed core end are first aligned.

7. The method of claim 4, wherein prior to aligning the first exposed core end of the first pin and the second exposed core end, the external power wire is sheathed with the insulating sleeve; following the pulling of the first pin of the thermostat and the external power wire towards opposite directions, the insulating sleeve is moved to sheathe the bent part and the soldered common joint.

8. The method of claim 5, wherein prior to aligning the first exposed core end of the first pin and the second exposed core end, the external power wire is sheathed with the insulating sleeve; following the pulling of the first pin of the thermostat and the external power wire towards opposite directions, the insulating sleeve is moved to sheathe the bent part and the soldered common joint.

9. The method of claim 6, wherein prior to aligning the first exposed core end of the first pin and the second exposed core end, the external power wire is sheathed with the insulating sleeve; following the pulling of the first pin of the thermostat and the external power wire towards opposite directions, the insulating sleeve is moved to sheathe the bent part and the soldered common joint.

10. A connector, comprising:
a thermostat of a motor, the motor comprising stator windings comprising an enameled wire, the thermostat comprising a first pin and a second pin, the first pin comprising a first exposed core end; and
an external power wire comprising a second exposed core end;
wherein
the first pin of the thermostat is electrically connected to the external power wire; the second pin of the thermostat is electrically connected to the enameled wire of the stator windings of the motor;
the first exposed core end of the first pin and the second exposed core end of the external power wire are intertwined and soldered to form a soldered common joint;
the first pin of the thermostat and the external power wire are pulled towards opposite directions, and a relatively longer core end of the first exposed core end and the second exposed core end is bent to form a bent part; and
the bent part and the soldered common joint are arranged side by side, and are sheathed in an insulating sleeve.

11. The connector of claim 10, wherein the first exposed core end is longer than the second exposed core end, and the bent part is formed by the first exposed core.

12. The connector of claim 10, wherein the second exposed core end is longer than the first exposed core end, and the bent part is formed by the second exposed core end.

13. The connector of claim 10, wherein prior to intertwining and soldering the first exposed core end of the first pin and the second exposed core end of the external power wire, the first exposed core end of the first pin and the second exposed core end are aligned.

14. The connector of claim 10, wherein prior to aligning the first exposed core end of the first pin and the second exposed core end, the external power wire is sheathed with the insulating sleeve; following the pulling of the first pin of the thermostat and the external power wire towards opposite directions, the insulating sleeve is moved to sheathe the bent part and the soldered common joint.

15. A motor, comprising:
a rotary shaft;
a rotor assembly;
a stator assembly comprising a stator core and stator windings;
a shell assembly; and
a thermostat;
wherein
the rotor assembly is disposed on the rotary shaft; the stator assembly and the shell assembly are sleeved on the rotor assembly; two ends of the rotary shaft are supported by bearings of the shell assembly; the stator windings are coiled on the stator core; the thermostat is disposed on the stator assembly;
the thermostat comprises a first pin and a second pin; the first pin of the thermostat is electrically connected to an enameled wire on the stator windings, and the second pin of the thermostat is electrically connected to an external power wire;
the first pin comprises a first exposed core end, and the external power wire comprises a second exposed core end; and
the thermostat and the external power wire are connected to form the connector of claim 10.
